(19) United States
(12) Patent Application Publication
(10) Pub. No.: US 2003/0065529 A1
(43) Pub. Date: Apr. 3, 2003

(54) Generic customer-initiated content processing

(76) Inventors: Balaji Pitchaikani, Los Altos Hills, CA (US); Milton Hernandez, River Edge, NJ (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/233,255

(22) Filed: Aug. 30, 2002

Related U.S. Application Data
(60) Provisional application No. 60/316,286, filed on Aug. 31, 2001.

(51) Int. Cl. G06F 17/60

(52) U.S. Cl. 705/1

(57) ABSTRACT

The invention includes a method and a computer-readable medium having computer-executable instructions for creating a content transaction system for a network billing system. The inventive method includes providing a user interface that identifies one or more business domain objects for the transacting of data over a network. The inventive method receives a selection of one or more business domain objects and a configuration of the selected business domain objects based on a customer's desired data analysis process for a network billing system. The inventive method then processes the data as a function of the configuration. The user may make the desired selections and configurations via a computer network, like a wide area network, a local area network, and/or the Internet. Also, the computer network may be a private network dedicated to an organization and/or a service provider network. The user interface may be a graphical user interface.

### CROSS REFERENCE TO RELATED APPLICATIONS

This application claims priority under 35 U.S.C. §119 (e) from provisional application No. 60/316,286 filed, Aug. 31, 2001. The provisional application No. 60/316,286 is incorporated by reference herein, in its entirety, for all purposes.

### TECHNICAL FIELD

The invention relates generally to the processing of data, and more particularly to permitting customers to create a generic data content evaluation process.

### BACKGROUND OF THE INVENTION

Recently, the collection and processing of data transmitted over communication networks, like the Internet, has moved to the forefront of business objectives. In fact, with the advent of the Internet, new revenue generating business models have been created to account for the consumption of content received from a data network (i.e., content-based billing). For example, content distributors, application service providers (ASPs), Internet service providers (ISPs), and wireless Internet providers have realized new opportunities based on the value of the content and services that they deliver.

To date, however, capturing this value and thus capitalizing on these opportunities has been accomplished with a variety of different business processes. In particular, each technology and each market tends to create unique billing processes. In fact, unique billing procedures often vary with the type of service provided within these markets. These unique billing procedures typically are captured in the many varied and application-specific (i.e., “non-generic” or custom) software implementations. For example, in the context of content-based billing, there may be one software application for collecting the content, another software application for aggregating the content, and yet another application for rating and billing for the content. While these “hard-coded” techniques are sufficient to accommodate only specific business environments, they are too specific to operate across the many and varied transaction environments and domains that exist throughout the business world.

As a result of these fractured and specific efforts, the software implementations are unable to keep pace with the ever-changing needs of the user or customer of the billing system. This is due, in large part, to the requirement that each change be addressed with a “re-making” of the software implementation. Such re-making requires a time-consuming and expensive manual effort. As a result, a customer willing to try to keep pace with the changing requirements must maintain expensive software development expertise. This problem is prevalent not only in end-to-end content billing environments, but in other electronic data transactions, like analyzing the type of data transmitted over a particular network, or determining the routing patterns of data on a network, for example. Also, the problem exists in traditional business environments, like commodity trading (e.g., grains, crude oil).

Therefore, there exists a need to provide a flexible technique that can capture and evaluate services provided in any business domain without requiring modification of the technique for each type. Such a technique would serve to accommodate multi-faceted networked environments like the Internet, as well as to provide a single solution that would apply to any business environment.

### SUMMARY OF THE INVENTION

The invention includes a method and a computer-readable medium having computer-executable instructions for creating a content transaction system for a network billing system. The inventive method includes providing a user interface that identifies one or more business domain objects for the transacting of data over a network. The inventive method receives a selection of one or more business domain objects and a configuration of the selected business domain objects based on a customer's desired data analysis process for a network billing system. The inventive method then processes the data as a function of the configuration. The user may make the desired selections and configurations via a computer network, like a wide area network, a local area network, and/or the Internet. Also, the computer network may be a private network dedicated to an organization and/or a service provider network. The user interface may be a graphical user interface. Also, the business domain objects may be depicted as icons on the graphical user interface. The business domain objects may correlate data, aggregate data, filter data, rate data, and derive data. Also, the business domain objects may identify ownership of the data and/or identify relationships among the ownership.

The invention also contemplates a computer system having a graphical user interface that provides a method of selecting and configuring one or more operations from a menu on the display. This may be accomplished by retrieving one or more operations that define the transacting of content on a network and displaying the operations on the menu as icons. The inventive method may provide a way of receiving a selection signal indicative of the user selecting one or more operations from the menu. In response to the selection signal, the selected icon may be highlighted. The inventive method may then display the selected operations in a process flow menu on the display. A user may then provide a configuration signal indicative of the user's locating the selected operations in the process flow menu with respect to other selected operations. The method may then process data associated with the transaction in accordance with the configuration of the selected operations in the process flow menu. The operations may be discrete and/or composite business domain objects. The selection signal may be received via a computer network, including a wide area network, a local area network, the Internet, a private network dedicated to an organization, and/or a service provider network. The operations may correlate data, aggregate data, filter data, rate data, and/or derive data. The operations also may identify ownership of the data and/or identify relationships among the ownership. The above methods also may be accomplished in a computer-readable medium having computer-executable instructions.

### BRIEF DESCRIPTION OF THE DRAWINGS

Other features of the invention are further apparent from the following detailed description of the embodiments of the invention taken in conjunction with the accompanying drawings, of which:

FIG. 1 is a block diagram of a system for analyzing content transmitted over a communication network, according to the invention;

FIG. 2 is a block diagram further describing the components of the system described in FIG. 1;

FIGS. 3A and 3B provide a flow diagram further detailing the operation the system described in FIG. 1; and

FIG. 4 provides an illustration of one example of a graphical user interface, according to the invention.

### DETAILED DESCRIPTION OF THE INVENTION

System Overview

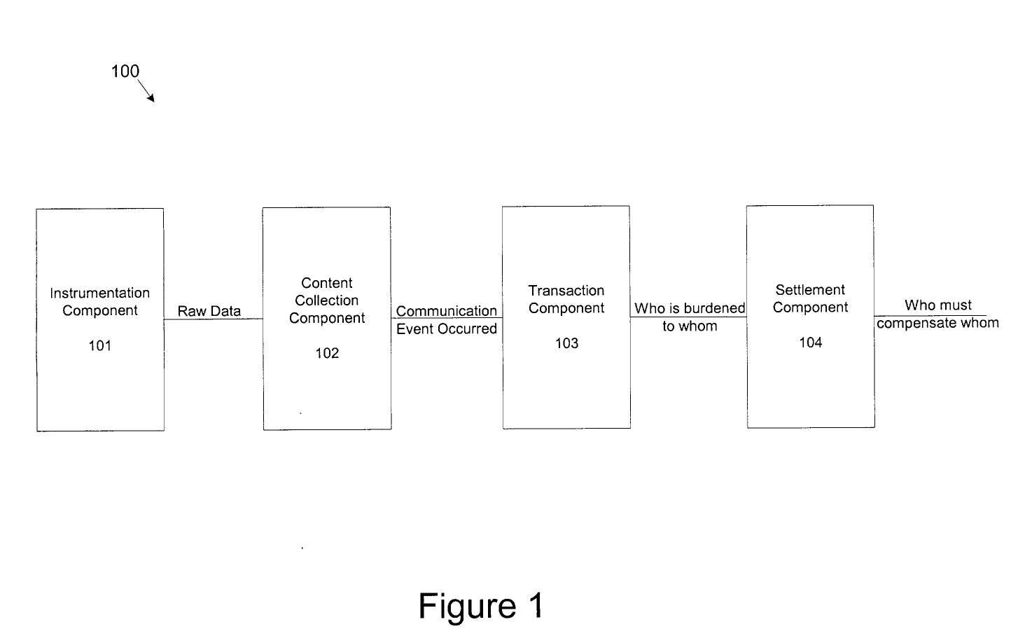

FIG. 1 is a block diagram of a system 100 for analyzing content transmitted over a communication network. Although the following description will be discussed in the context of collecting, processing and billing for data transmitted over the Internet, it should be appreciated that the invention is no so limited. In fact, the invention may be applied to any type of network, including a private local area network, a public local area network, a wide area network, a private network, and/or a service provider network, for example. Also, the invention may be used for purposes other than billing for the usage of content. For example, the invention may be used to analyze the type of data transmitted over a particular network, or to determine the routing patterns of data on a network. Furthermore, the invention may be used to facilitate the intelligent collection and aggregation of data relevant to a particular industry. In addition, the invention may be used to track specific Internet protocol (IP) network resources and to detect fraud, for example. It should also be appreciated that the invention may contemplate non-network and non-computer related business domains like commodity trading (e.g., grains, crude oil) where multiple parties are involved. Therefore, although the invention is often described in the context of the Internet, it should be appreciated that the invention may equally applied to traditional business environments.

In addition, it should be appreciated that the term “content” may be defined as data that is transmitted over the network. In the context of the Internet, content may include .mp3 files, hypertext markup language (html) pages, videoconferencing data, and streaming audio, for example. In the traditional business setting, content may include services and/or goods provided in a typical commerce stream. The terms “content provider” and “customer” also will be used throughout the description as well. Content provider may refer to the primary creator or provider of the content, while customer is the primary recipient of the content. Both the producer and customer may be a human or a computer-based system.

As shown in FIG. 1, an instrumentation component 101 provides raw data to a content collection component 102. Instrumentation component 101 may consist of various data sources, for example, network routers. The network routers may provide information regarding the various types of routed data, including for example, data format, originating Internet protocol (IP) address, and destination IP address. One example of such information is Cisco System's NetFlow™.

Content collection component 102 collects information about the delivery of the content, as well as the substance of the content itself. Content collection component 102 also may sort, filter, aggregate, correlate, and store the content according to the particular needs of the end user. In effect, content collection component 102 is responsible for extracting meaningful information about IP traffic, and so it is provided with an understanding of the data sources in instrumentation component 101. Content collection component 102 also may transform the data from the plurality of sources in instrumentation component 101 into standard formats for use in a transaction component 103.

Content collection component 102 is in communication with transaction component 103. Generally, content collection component 102 reports to transaction component 103 that a relevant communication event has occurred and should be considered by the remainder of system 100. A communication event may be defined as any transfer of data between systems. Transaction component 103 captures the predetermined agreements among all of the parties involved in system 100 regarding the value of the transferred content, as well as the value added by each of the individual parties in transferring such content. Therefore, transaction component 103 is charged with understanding the nature of the parties, as well as the understanding the actions that one or more parties perform and the influence of such action on the respective parties.

Transaction component 103 is in communication with a settlement component 104. Settlement component 104 captures the operations that are necessary to understand the significance of the transaction defined by transaction component 103. For example, settlement component 104 may rate a particular transaction by assigning a monetary value to the transaction. Settlement component 104 also may divide the burdens and benefits of the monetary value among the relevant parties. In this way, settlement component 104 ensures that certain parties receive a particular portion of the payment made by the other parties. Settlement component 104 also may be responsible for delivering this burden and benefit information to the appropriate parties with the appropriate identifiers (e.g., account numbers).

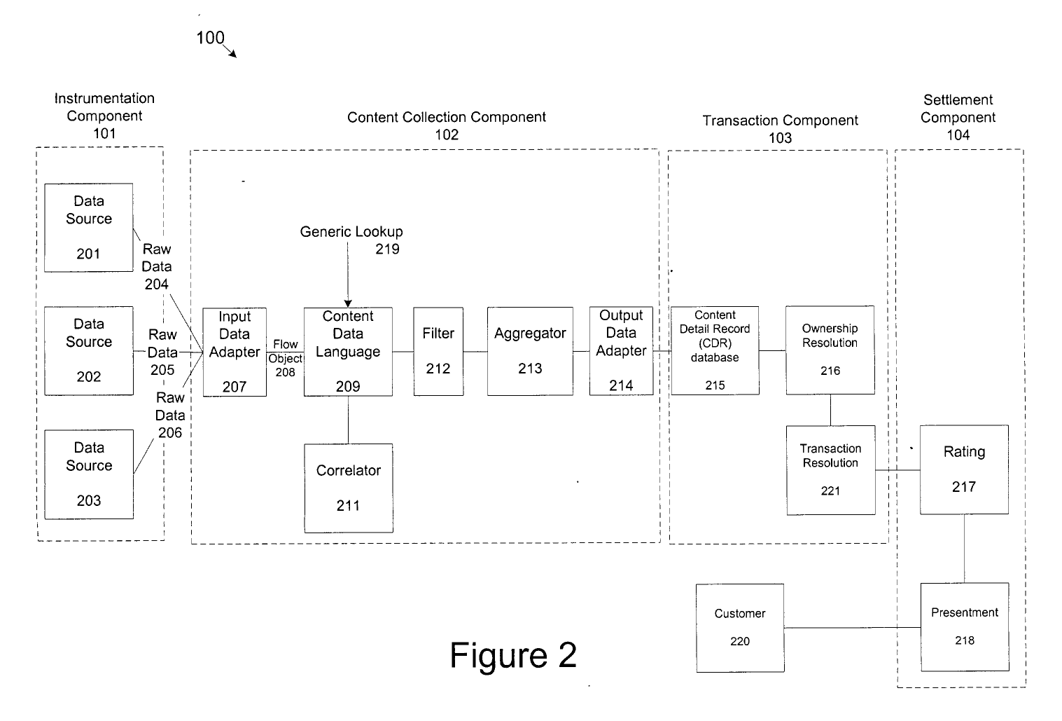

FIG. 2 is a block diagram further describing the components of system 100. As shown in FIG. 2, instrumentation component 101 includes data sources 201-203 that each provide raw data 204-206, respectively, to collection component 102. As discussed, data sources 201-203 may include various internetworking devices like routers, bridges, and network switches. Data sources 201-203 provide raw data to an input data adapter 207. Accordingly, input data adapter 207 understands the operation of and the data provided by data sources 201-203. Although one input data adapter is shown in FIG. 2, it should be appreciated that more than one input data adapter may be used in system 100. For example, each data source may have a dedicated input data adapter.

Input data adapter 207 understands the incoming data and extracts the data into the appropriate fields. This field-delimited data, called flow objects 208, are sets of attributes. The attributes may be any characteristics that are provided by, or can be derived from, raw data 204-206 provided by data sources 201-203, respectively. For example, flow objects 208 may include a set of attributes describing the source and destination, including source IP address, destination IP address, source interface, and destination interface. Because input data adapter 207 is charged with understanding raw data 204-206 from data sources 201-203, as well as the required flow objects 208 of system 100, it is capable of transforming the raw data to the flow objects, where the flow objects may all be of a standard format.

Input data adapter 207 provides flow objects 208 to a content data language 209. Content data language 209 may transform the attributes in flow objects 208 into other attributes that are desired by a particular customer. For example, content data language 209 may derive a network identifier attribute that is not readily available from a data source, from a source address attribute and a destination address attribute that are provided by flow object 208 attributes from input data adapter 207. This derivation may be based on a customer's desire to determine which network conveyed the transaction between the source and the destination. Therefore, following this example, content data language 209 will know to extract the source address attribute and the destination address attribute from flow objects 208.

Content data language 209 may perform other functions as well. For example, content data language 209 may perform a generic lookup function 219 that is built into content data language 209. Generally, generic lookup 219 describes a technique for mapping any number of attributes to any number of other derived attributes. For example, generic lookup 219 may be used to map a unique resource locator (URL) attribute to a particular content-type attribute.

Content data language 209 also is in communication with a correlator 211. Generally, correlator 211 connects the many daily network content events from various network devices, like routers for example. Often, the connected data may come from distinctly different data sources at distinctly unrelated times. Correlator 211 allows this data to be intelligently connected to each other, regardless of how different the sources or of how disparate the time received. For example, a Netflow™ enabled router and a Radius™ enabled network access switch may each provide certain data that is relevant to one particular transaction. However, because portions of the data come from different devices, the data may arrive at system 100 at different times, and in different formats. Also, because each provides data that is necessary to complete one transaction, the data from each cannot be considered separately. Correlator 211 allows this data to be intelligently grouped regardless of the format of the data or of the time the data pieces are received.

Furthermore, correlator 209 may rearrange the order of the received flow objects 208 to suit the needs of the remainder of system 100. By performing such correlation without having to first store all of the data on a disk (e.g., a database), significantly faster processing is achieved. Correlator 209 may perform this correlation in real-time, for example.

Although system 100 has been described using content data language 209 and correlator 211, it should be appreciated that flow objects 208 may proceed directly to a filter 212, if no correlation is required and if no attribute derivation is required, for example. Filter 212 analyzes flow objects 208 to ensure that the provided attributes are desired by system 100. If flow objects 208 are not needed (i.e., a mismatch), filter 212 may prevent flow objects 208 from passing to an aggregator 213. Also, although filter 212 has been shown as a separate device in system 100, it should be appreciated that the functionality of filter 212 may be incorporated into aggregator 213.

Filter 212 passes the matching flow objects to aggregator 213. Aggregator 213 may provide additional filtering and classification of the multitude of daily network content transactions, based on user criteria. Aggregator 213 may perform such filtering and classification in real-time. Aggregator 213 provides the filtered and classified information to an output data adapter 214. Output data adapter 214 may convert the data from aggregator 213 into one or more content detail records for storage in CDR database 215. Therefore, CDR database 215 stores a complete description of a content event.

Transaction component 103 includes CDR database 215, an ownership resolution component 216, and a transaction resolution component 221. CDR database 215 passes the CDR onto ownership resolution component 216. A proper accounting of a communication event, for any purpose including billing, requires both identifying the participants and defining the relationships among those participants. These tasks are accomplished by ownership resolution component 216 and transaction resolution component 221.

Ownership resolution component 216 serves to define the direct and indirect participants of the communication event. In particular, because raw data 204-206 may not provide sufficient “ownership” data relating to the parties involved in the content transaction, such “ownership” data must be provided by system 100 to properly account for the entire transaction. Ownership resolution component 216 operates to provide such ownership-based data to system 100.

Ownership resolution component 216 is in communication with transaction resolution component 221. Transaction resolution component 221 serves to capture the predetermined relationships and/or agreements among the parties defined by ownership resolution component 216 regarding the value of the transferred content, as well as the value added by each of the individual parties in transferring such content. Such predetermined relationships may be previously agreed upon by the participants, or may be created and agreed upon with the implementation of system 100. Therefore, transaction component 103 understands the nature of the parties, the actions that one or more parties perform, and the influence of such action on the respective parties. Ownership resolution component 216 and transaction resolution component 221 will be discussed in greater detail.

Transaction component 216 provides the transaction information to a rating component 217. Rating component 217 provides a weight or significance (e.g., a price) to the transaction, so as to provide a tangible value to the transaction. Rating component 217 may make this determination based on various metrics including the type of the content, the quantity of content consumed, the place and time delivered, or the quality of the content, for example. Therefore, rating component 217 allows system 100 to provide some contextual value, indicting the significance or relevance that certain content or information has to the individual customer.

Rating component 217 provides the rated transaction to a presentment component 218. Presentment component 218 may provide the capability for a customer 220 to view their real-time billing information, for example, over the network. Presentment component 218 also may attach relevant identifiers to the bill (e.g., account numbers, etc.).

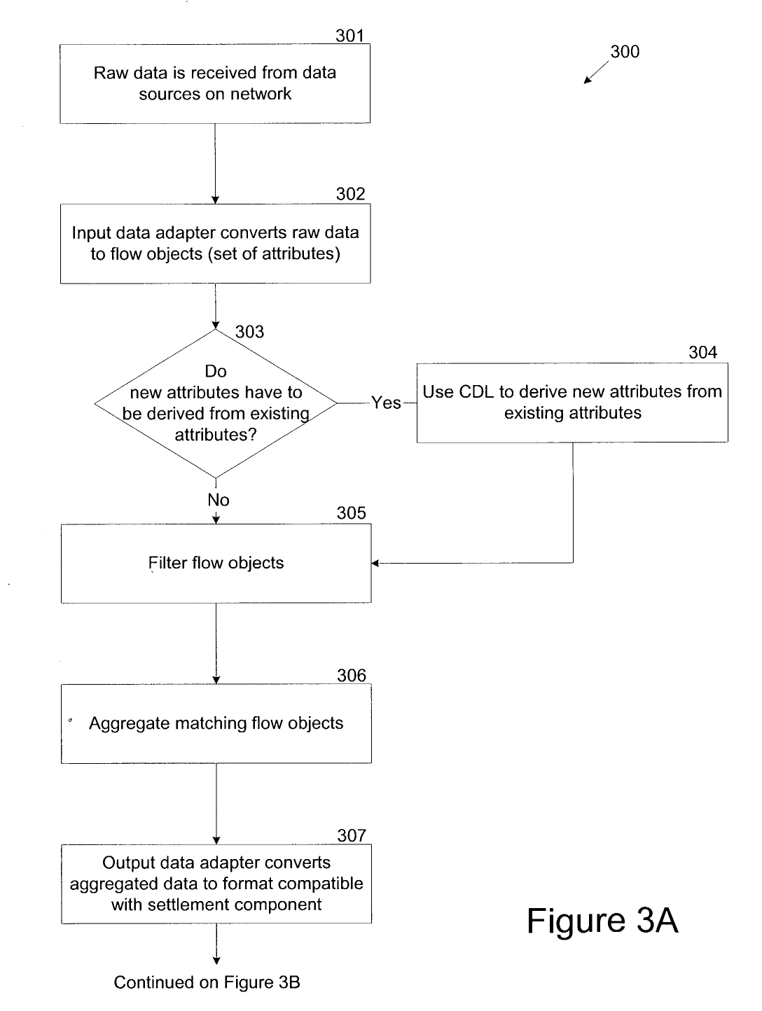

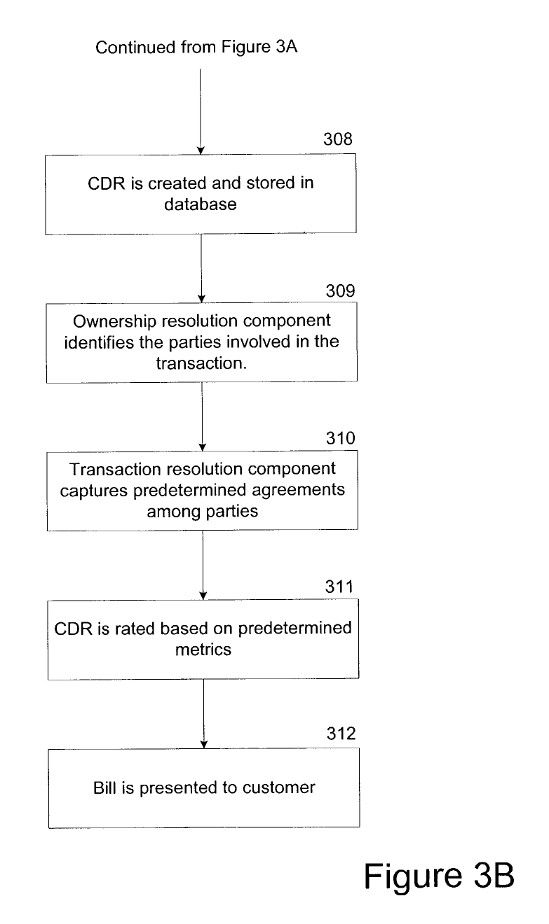

FIGS. 3A and 3B provide a flow diagram further detailing the operation 300 of system 100. As shown in FIG. 3A, in step 301, raw data 204-206 is received from data sources 201-203. In step 302, input data adapter 207 converts raw data 204-206 to flow objects 208, where flow objects 208 are sets of attributes, determined from raw data 204-206. In step 303, it is determined whether there is a need to derive new attributes from the existing attributes found in flow objects 208. If there is such a need, in step 304, CDL 209 is used to derive new attributes from existing attributes.

CDL 209 may serve to provide configuration-driven transformations of the attributes provided by flow objects 208. Also, CDL 209 may serve to derive new attributes from the existing attributes provided by flow objects 208. The transformations performed by CDL 209 represent the need for certain attributes that may be desired by a particular customer. This is especially pertinent in the context of content-based billing on a diverse network, like the Internet. Specifically, transformation of provided attributes to other derived attributes may be necessary to accommodate the attributes that are required by legacy billing systems. CDL 209 is able perform a number of functions, including function calls, mathematical operators, lookup invocations, conditional processing and assignment. It should be appreciated, however, that the operation of CDL 209 is not limited to the described functionality. Instead, the described functionality is meant to provide examples of the ability of CDL 209 to derive new attributes from given attributes. CDL 209 is further discussed in U.S. Patent Application Attorney Docket No. APOG-0003, filed Aug. 21, 2001, and entitled “Content Data Language,” which is incorporated herein by reference. Also, as discussed above, attributes may be correlated by correlator 211.

In step 305, flow objects 208 are filtered by filter 212. In step 306, the matching flow objects (i.e., those passed by filter 212) are further filtered and classified by aggregator 213. Aggregation is the process of filtering, classifying, and applying logical or mathematical function to data, based on user criteria. The process is conducted generically (i.e., without data-specific instructions) based on a predetermined criteria. The generic aggregation permits the data to be stored in an in-memory or non-permanent memory portion of the database that typically responds faster than permanent memory devices.

The aggregation process may be accomplished both as the data is received in real-time and offline. The aggregation process may create one or more records that provide information sufficient to adequately describe a transaction or event. Aggregation may apply to any of the “attributes” of the data.

Although aggregator 213 is shown as a component of system 100, it should be appreciated that the aggregator may be accomplished by a list of computer-readable instructions (e.g., an aggregation file) located on anywhere within the system. Aggregator 213 is located in the block of FIG. 2 to facilitate the discussion of the operation of the system. The aggregation process is further discussed in U.S. Patent Application No. 60/298,622 filed Jun. 15, 2001, and entitled “Generic Data Aggregation,” which is incorporated herein by reference. In step 307, output data adapter 214 converts the data aggregated by aggregator 213 to a format compatible with transaction component 103.

As shown in FIG. 3B, in step 308, output adapter 214 may format the aggregated data into one or more content data records for storage in CDR database 215. In step 309, ownership resolution component 216 identifies the parties involved in the transaction. Ownership resolution component 216 reads a usage record, and applies rules to the usage record, so as to determine one or more “accountables.” Accountables are labels that are used to facilitate identifying the parties or owners to a transaction. Accountables may be defined and/or modified by an external user (e.g., a customer) using a graphical user interface. Also, it should be appreciated that accountables may be defined for a new usage types for which no rules are provided. The ownership resolution process is further discussed in U.S. Patent Application Attorney Docket No. APOG-0005, filed Aug. 21, 2001, and entitled “Content Ownership Resolution,” which is incorporated herein by reference.

In step 310, transaction resolution component 221 captures the predetermined agreements among the parties, as well as the value added by each of the individual parties. Transaction resolution component 221 identifies “contracts” that define the relationships or agreements between one or more accountables. In the context of a billing system, a contract identifies which party pays (i.e., the billed party) and which party receives payment (i.e., the billing party). A particular contract may be identified and executed when one based on “conditions” are satisfied, however, such conditions may not be required. The transaction resolution process is further discussed in U.S. Patent Application Attorney Docket No. APOG-0004, filed Aug. 21, 2001, and entitled “Content Transaction Resolution,” which is incorporated herein by reference.

In step 311, the CDR is rated based on predetermined metrics (e.g., time of transmission, quality of content). In step 312, a bill is presented to the customer.

Generic Customer-Initiated Content Processing

Each of the components identified in content collection component 102, transaction component 103, and settlement component 104 perform certain functions that may be necessary to convert raw data 204-206 into a final product (e.g., a bill), desired by the customer. The components are not limited to the configuration depicted in FIGS. 1 and 2. For example, the components or operations may be divided further into more discrete functional components. Alternatively, individual components may be combined into more composite components. The division of functionality into the blocks depicted in FIG. 2 is provided solely for the purposes of clarity and to facilitate a discussion of the invention. Also, it should be appreciated that the functionality discussed with reference to FIGS. 1-3B may be located in whole or in part on a computer-readable medium having computer-executable instructions for performing the functions. Alternatively, the functionality may be located on various computer-readable mediums that are able to communicate with each other. Accordingly, it should be appreciated that the invention is not limited to any physical constrictions on the placement or configuration of the described functionality.

The components also are not limited to the placement identified in FIG. 2. The placement of the components were designated as such simply to facilitate a discussion of their various operations performed on raw data 204-206. In fact, the various components and the functions they serve, may be arranged in any order consistent with the desires of the customer or user.

This flexibility of the various components is provided by the generic nature of the components with respect to the specific characteristics and format of raw data 204-206. In fact, because the components are not written specifically to manipulate a certain type of raw data, they may be rearranged. Each component's functionality is described by a primitive or business domain objects (BDO) based on certain desired functionality, as previously discussed. It should be appreciated that the terms primitive or BDO will be used interchangeably. Each BDO is generic in that it operates independently of its input and/or output. In fact, each BDO is created to be interchangeable with another BDO, such that the output of a first BDO may be processed by a second BDO, and the output of the second BDO may be processed by the first BDO, etc.

This interchangeability permits a business process to be created and/or modified by easy-to-use implementation initiatives. In particular, the customer is able to rearrange the primitives or BDO based on certain desired functionality. For example, in certain instances consistent with the examples expressed thus far, a billing manager may aggregate flow objects 208 with aggregator 213 before deriving additional attributes with CDL 209 and/or before correlating the data with correlator 211. This may be desired, for example, in a business environment that must receive and process more data than other businesses, for example. In another example, a billing manager may conduct ownership resolution 216 and transaction resolution 221 before deriving additional attributes with CDL 209. This may be desired, for example, in a business environment with few and well-defined participants whose relationships are constant.

Because each primitive or BDO is generic, a customer may create new primitives or BDOs, as well as reorganize their position in the overall process intuitively, rather than through more complex software programming initiatives. In one embodiment, for example, the customer may use a computer-based graphical user interface (GUI) to create and modify a particular business process. In such an embodiment, the GUI may represent each created BDO as an icon. The customer or billing manager may rearrange the business process simply by rearranging the order of the icons as they appear on the computer screen. The order may be graphically represented, for example, by a flow diagram or workflow type of graphical representation. As a result, the billing manager may create and update a particular business process in real-time, without having to involve the time-consuming and complex software programming techniques.

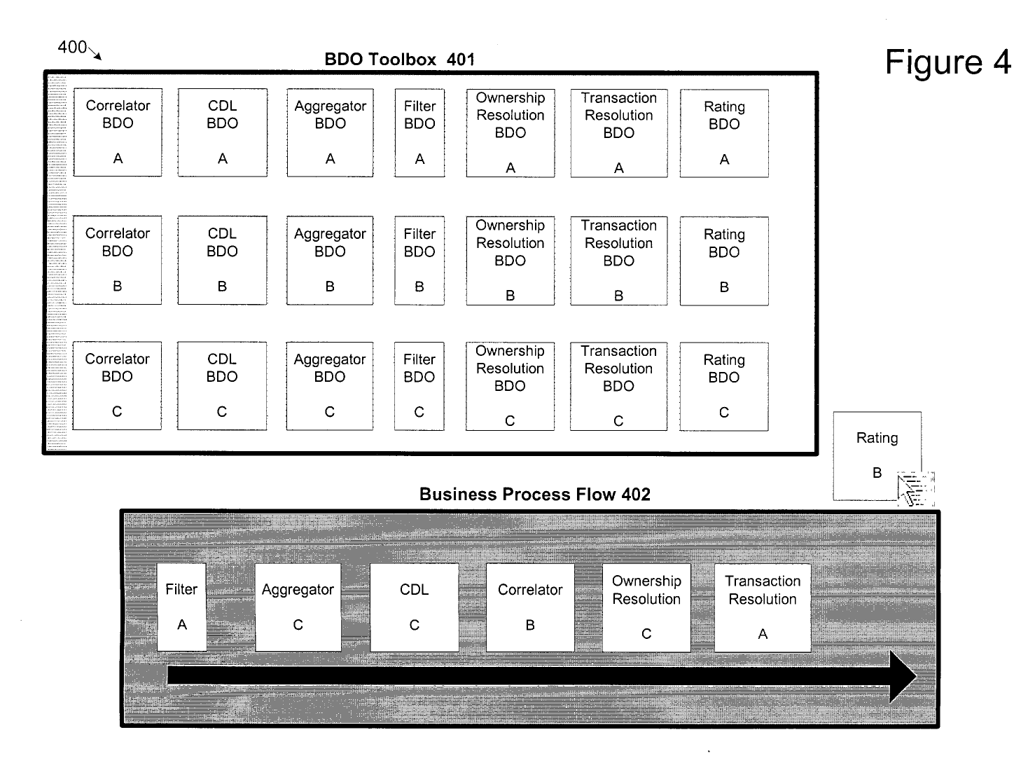

FIG. 4 provides one example of a computer-based GUI 400 that may be presented to a customer. As is typical in computing systems, GUI 400 may be displayed on a computer display that is in communication with a computer processor, where the computer processor has a computer-readable medium having computer-executable instructions. The user may interact with the computer-readable medium (and thus execute the computer-executable instructions) using an input device, like a mouse, keyboard, and/or voice-activated software via a microphone. It should be appreciated that the example of FIG. 4 is provided for the purpose of explanation, and is not meant to be an exclusive representation of such a GUI and/or computing system.

As shown in FIG. 4, a BDO toolbox 401 contains various BDOs. Each BDO is described by its functionality. For example, there are three BDOs for correlation, three BDOs for aggregation, and so on. BDO toolbox 401 may represent all of the BDOs currently available to the customer. The customer selects various BDOs from BDO toolbox 401 and places the selected BDO in a business process flow 402. When the customer makes the selection (e.g., using a mouse and/or keyboard) a selection signal may be sent to a computer-readable medium to execute the desired selection. Business process flow 402 represents the organization of the desired BDOs, from left to right. Rating “B” BDO is shown being moved from BDO toolbox 401 to business process flow 402. Therefore, the customer who already understands the functionality available from each BDO is able to create unique business flows intuitively using GUI 400, with little or no software programming knowledge. When the user configures the selected BDOs, a configuration signal may be sent to a computer-readable medium to execute the desired configuration.

This flexible graphical user interface is available to the customer or billing manager because each BDO is generic in that it operates independently of its input and/or output. In fact, each BDO is created to be interchangeable with another BDO, such that the output of a first BDO may be processed by a second BDO, and the output of the second BDO may be processed by the first BDO.

The invention is directed to a system and method of creating a data analysis process. The invention often was described in the context of the Internet, but is not so limited to the Internet, regardless of any specific description in the drawing or examples set forth herein. For example, the invention may be applied to wireless networks, as well as non-traditional networks like Voice-over-IP-based networks, private networks, and/or traditional business environments like commodity trading. Also, although the invention was described in the context of network billing systems, it should be appreciated that the invention equally may apply to other data collection environments, like commodity trading for example. It will be understood that the invention is not limited to the use of any of the particular components or devices herein. Indeed, this invention can be used in any application that requires the creation of a data analysis process. Further, the system disclosed in the invention can be used with the method of the invention or a variety of other applications.

While the invention has been particularly shown and described with reference to the embodiments thereof, it will be understood by those skilled in the art that the invention is not limited to the embodiments specifically disclosed herein. Those skilled in the art will appreciate that various changes and adaptations of the invention may be made in the form and details of these embodiments without departing from the true spirit and scope of the invention as defined by the following claims.

What is claimed is:

1. A method of creating a data analysis process for a network billing system, comprising:
providing a user interface that identifies one or more business domain objects for the transacting of data over a network;
receiving a selection of one or more business domain objects;
receiving a configuration of the selected business domain objects based on a desired data analysis process for a network billing system; and
processing the data as a function of the configuration.

2. The method of claim 1, wherein the selection is received via a computer network.

3. The method of claim 2, wherein the computer network is at least one of the following: a wide area network, a local area network, and the Internet.

4. The method of claim 2, wherein the computer network is a private network dedicated to an organization.

5. The method of claim 2, wherein the computer network is a service provider network.

6. The method of claim 1, wherein the configuration is received via a computer network.

7. The method of claim 6, wherein the computer network is at least one of the following: a wide area network, a local area network, and the Internet.

8. The method of claim 1, wherein the user interface is depicted graphically and wherein the business domain objects are depicted as icons on the graphical user interface.

9. The method of claim 1, wherein the business domain objects accomplish at least one of the following: correlate data, aggregate data, filter data, rate data, and derive data.

10. The method of claim 1, wherein the business domain objects identify ownership of the data.

11. The method of claim 10, wherein the business domain objects identify relationships among the ownership.

12. The method of claim 1, wherein the business domain objects are represented by computer-executable instructions located on a computer-readable medium.

13. In a computer system having a graphical user interface comprising a display and a user selection device, a method of providing and selecting one or more operations from a menu on the display, the method comprising:
retrieving one or more operations that define the transacting of content on a network, wherein the transaction is part of a network billing system;
displaying the operations on the menu as icons;
receiving a selection signal indicative of the user selection device identifying one or more selected operations from the menu, and in response to the selection signal highlighting the icons associate with the selected operations;
displaying the selected operations in a process flow menu on the display;
receiving a configuration signal indicative of the user selection device locating the selected operations in the process flow menu with respect to other selected operations; and
processing data associated with the transaction in accordance with the configuration of the selected operations in the process flow menu.

14. The method of claim 13, wherein the operations are business domain objects.

15. The method of claim 13, wherein the operations are discrete operations.

16. The method of claim 13, wherein the operations are composite operations.

17. The method of claim 13, wherein the selection signal is received via a computer network.

18. The method of claim 17, wherein the computer network is at least one of the following: a wide area network, a local area network, and the Internet.

19. The method of claim 17, wherein the computer network is a private network dedicated to an organization.

20. The method of claim 17, wherein the computer network is a service provider network.

21. The method of claim 13, wherein the configuration signal is received via a computer network.

22. The method of claim 21, wherein the computer network is at least one of the following: a wide area network, a local area network, and the Internet.

23. The method of claim 21, wherein the computer network is a private network dedicated to an organization.

24. The method of claim 21, wherein the computer network is a service provider network.

25. The method of claim 13, wherein the operations accomplish at least one of the following: correlate data, aggregate data, filter data, rate data, and derive data.

26. The method of claim 13, wherein the operations identify ownership of the data.

27. The method of claim 13, wherein the operations identify relationships among the ownership.

28. The method of claim 13, wherein the operations are represented by computer-executable instructions located on a computer-readable medium.

29. A computer-readable medium having computer-executable instructions for creating a content transaction system, wherein the computer-executable instructions comprise:
displaying a graphic user interface identifying one or more business domain objects that define discrete operations for billing the use of content on a network;
providing for a selection of one or more of the business domain objects using the graphical user interface;
providing for a configuring of the selected business domain objects using the graphical user interface, based on a desired business process flow; and
processing the content transaction as a function of the business process flow.

30. The method of claim 29, wherein the content transaction system is a content billing system.

31. The method of claim 29, wherein each of the business domain objects are capable of receiving data from another business domain object.

32. The method of claim 29, wherein each of the business domain objects are capable of transmitting data to another business domain object.

33. The method of claim 29, wherein each of the business domain objects are generic and capable of being configured in any order.
